(19) United States
(12) Patent Application Publication
(10) Pub. No.: US 2008/0171012 A1
(43) Pub. Date: Jul. 17, 2008

(54) Fouling Resistant Coatings and Methods of Making Same

(76) Inventors: Phillip Messersmith, Clarendon Hills, IL (US); Andrea R. Statz, Evanston, IL (US); Bruce P. Lee, Madison, WI (US); Jeffrey L. Dalsin, Madison, WI (US); Daniel Sherman, Madison, WI (US)

Correspondence Address: Northwestern University;c/o Quarles & Brady LLP, 411 East Wisconsin Ave, Suite 2040, Milwaukee, WI, 53202-4497, US

(21) Appl. No.: 11/972,008

(22) Filed: Jan. 10, 2008

Related U.S. Application Data
(60) Provisional application No. 60/879,873, filed on Jan. 11, 2007.

(51) Int. Cl. C09D 5/16

(52) U.S. Cl. 424/78.09

(57) ABSTRACT

The invention provides surface treatments that reduce or eliminate marine biofouling of various surfaces. A surface that is to be subjected to a marine environment can be treated with a mPEG-DOPA. The treated surface is thus rendered less susceptible to fouling of the surface.

### CROSS REFERENCE TO RELATED APPLICATIONS

This application claims benefit under 35 U.S.C. §119(e) to U.S. Ser. No. 60/879,873, entitled “Fouling-Resistant Coatings and Methods of Making Same”, filed Jan. 11, 2007 (attorney docket number NU26168) by Phillip B. Messersmith et al., the contents of which are incorporated herein by reference in their entirety.

### STATEMENT REGARDING FEDERALLY SPONSORED RESEARCH OR DEVELOPMENT

The present invention was made with government support from the National Institute of Health, Grant No. DE14193. The United States Government has certain rights in the invention.

### FIELD OF THE INVENTION

The invention relates generally to methods and compositions to reduce or prevent marine fouling (biofouling) of surfaces.

### BACKGROUND OF THE INVENTION

As long as ships have plied the seas, biofouling has had an overwhelming economic impact for the marine industry. Traditional antifouling paints containing biocides such as cuprous oxide in combination with one or more co-biocides are generally effective in reducing fouling of marine surfaces, although their use is associated with significant concerns related to their environmental impact on non-target aquatic species.

Tributyltin-containing paints were found to be effective in reducing biofouling. However, the application of tributyltin-containing paints is no longer permitted under a ban imposed by the International Maritime Organization (IMO) and more environmentally friendly approaches to fouling control are being actively sought.

Commercial non-toxic alternatives to traditional biocidal antifouling paints have been silicone elastomers known as “fouling-release” coatings, which reduce the adhesion strength of marine organisms, facilitating their hydrodynamic removal at high speeds. These coatings, however, are expensive, not completely effective against all marine fouling including slimes, and do not release macrofouling from slow-moving vessels.

Therefore, the environmental and functional limitations of existing antifouling coatings highlight the need for new marine antifouling technologies.

### BRIEF SUMMARY OF THE INVENTION

The present invention surprisingly provides surface treatments that reduce or eliminate marine fouling of various surfaces. A surface that is to be contacted with the marine environment can be easily treated with an mPEG-DOPA, as disclosed herein. The treated surface is thus rendered less susceptible to fouling of the surface.

Suitable mPEG-DOPAs include those where a L-3,4-dihydroxyphenylalanine (DOPA) unit is “pegylated” with a methoxyl terminated polyethylene glycol (mPEG) sidechain. Typically there are 1, 2 or 3 DOPA units contained within the mPEG-DOPA polymer. The mPEG portion of the mPEG-DOPA polymer has a polyethylene glycol repeat unit of about 113 units. The polyethylene glycol (PEG) repeat unit can vary from several units to a few hundred units, or from about 2 to about 300, from about 5 to about 250, from about 10 to about 200, from about 20 to about 150, and all integers and ranges there between.

A surface in need of treatment can simply be coated with a solution of the mPEG-DOPA antifouling polymer. Alternatively, a solution of the mPEG-DOPA antifouling polymer could be sprayed onto the surface, brushed onto the surface, etc. to effect a suitable treatment of the surface.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE DRAWINGS

FIG. 1. Mussel adhesive-inspired mPEG-DOPA3 for reduction of marine fouling.

FIG. 2. XPS analysis indicates the presence of adsorbed mPEG-DOPA3 on modified Ti surfaces. High-resolution O(1s) (left) and C(1s) (right) XPS spectra of modified (top) and unmodified (bottom) Ti substrates.

FIG. 3. Settlement (A) and release (B) of Navicula on control and mPEG-DOPA3 coated slides. PDMSE is Silastic T2. Each point is the mean from 90 counts on 3 replicate slides. Bars represent 95% confidence limits. For removal of attached cells slides were exposed to a wall shear stress of 20 Pa.

FIG. 4. Settlement (A) and release (B) of U. linza spores on control and mPEG-DOPA3 coated slides. PDMSE is Silastic T2. Each point is the mean from 90 counts on 3 replicate slides. Bars show 95% confidence limits. For removal of attached cells slides were exposed to a wall shear stress of 53 Pa.

FIG. 5. Growth of U. linza sporelings after 8 days culture on control and mPEG-DOPA3-coated slides. Bars show the standard error of the mean from three replicate slides.

FIG. 6. Percent removal of U. linza sporelings after exposure to shear stress of 53 Pa in water channel. Bars show the standard error of the mean derived from arcsine transformed data from three replicate slides.

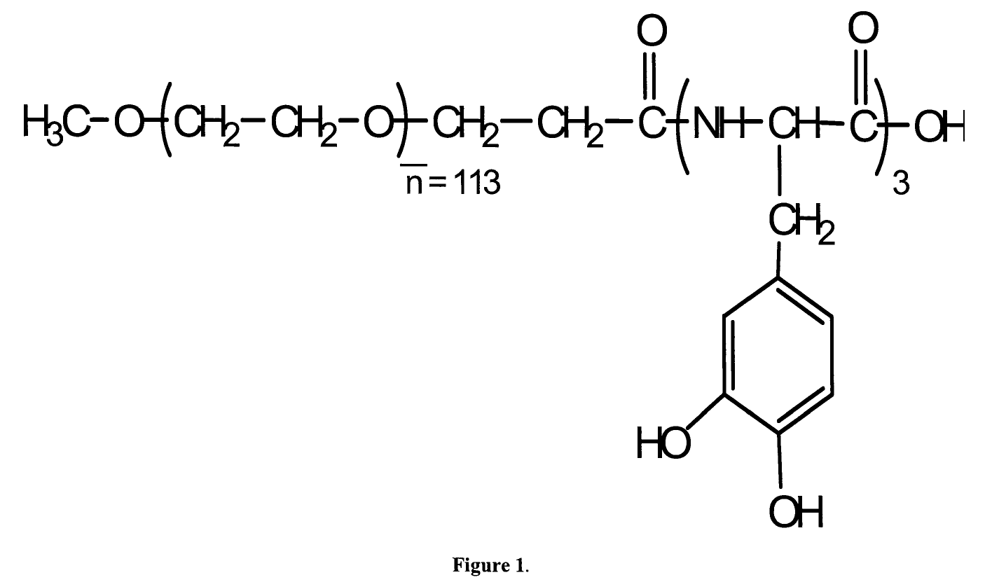

### DETAILED DESCRIPTION

The present invention surprisingly provides surface treatments that reduce or eliminate marine biofouling of various surfaces. A surface that is to be contacted with the marine environment can be easily treated with an mPEG-DOPA, as disclosed herein. The treated surface is thus rendered less susceptible to fouling of the surface.

The term “biofouling” is known in the art and refers to the attachment of an organism or organisms to a surface in contact with water for a period of time. There are several organisms that cause biofouling and many different types of surfaces affected by it.

Biofouling occurs worldwide in various industries, from offshore oil and gas industries, to fishing equipment, to cooling systems. One of the most common biofouling sites is on the hulls of ships, where barnacles are often found. One problem of growth on a ship is the eventual corrosion of the hull, leading to the ship's deterioration. If left unattended, organic growth can increase the roughness of the hull, thereby decreasing its maneuverability and increasing drag. Drag increases a ship's fuel consumption and in turn has economic and environmental consequences, as increased fuel consumption leads to increased output of greenhouse gases. Economic losses are tremendous, as fuel accounts for up to 50% of marine transportation costs.

Biofouling is found everywhere. Parts of a ship other than the hull are affected as well: heat exchangers, water-cooling pipes, propellers, even the ballast water. Heating and cooling system biofouling might also be found in power stations or factories.

Biofouling is a complex process that often begins with the production of a biofilm.

A biofilm is a film made of bacteria, such as Thiobacilli or other microorganisms that forms on a material when conditions are conducive for growth. Nutrient availability is an important factor as bacteria require dissolved organic carbon, humic substances and uronic acid for optimum biofilm growth. Biofilms do not have to contain living material; they may instead contain such once living material as dead bacteria and/or secretions. Bacteria are not the only organisms that can create this initial site of attachment (sometimes called the slime layer); diatoms, seaweed, and their secretions are also culprits. Coral reef diatoms' attachment depends on pH, and as in the Achnanthes and Stauronesis diatoms, the molecular structure of the organism.

The growth of a biofilm can progress to a point where it provides a foundation for the growth of seaweed, barnacles, and other organisms. In other words, microorganisms such as bacteria, diatoms, and algae form the primary slime film to which the macroorganisms such as mollusks, seasquirts, sponges, sea anemones, bryozoans, tube worms, polychaetes and barnacles attach.

Barnacles, encrusting bryozoans, mollusks, tube worms, and zebra mussels create a type of fouling known as calcareous (hard) fouling, while organisms such as algae, slimes and hydroids make up non-calcareous (soft) fouling.

The present invention provides compositions that include in the specification and in the claims, the terms “including” and “comprising” are open-ended terms and should be interpreted to mean “including, but not limited to . . . .” These terms encompass the more restrictive terms “consisting essentially of” and “consisting of.”

The term “mPEG-DOPA” or “mPEG-DOPA polymer” is intended to include polymers prepared by the general process of described in detail in “Protein resistance of titanium oxide surfaces modified by biologically inspired mPEG-DOPA”, Langmuir, 21, 640-646 (2005) by Dalsin et al. Briefly, mono-, di-, and tri-DOPA peptides (DOPA₁₋₃) were synthesized in solution from Boc/TBDMS-protected DOPA using standard carbodiimide chemistry. DOPA and DOPA peptides were deprotected and subsequently coupled to activated methoxy-PEG in the presence of 0.1 M sodium tetraborate buffer. The resulting polymer conjugate was characterized by MALDI-MS and ¹H NMR.

As noted above, the mPEG-DOPA polymer can be applied to a surface in any manner known by a person skilled in the art. The substrate can be painted, sprayed, dipped, washed, etc. with the polymer. The polymer can be included in a paint or other suitable carrier used, for example, in the marine industry.

The term “paint” is known in the art and is intended to include any liquid, liquifiable, or mastic composition which after application to a substrate in a thin layer is converted to an opaque solid film. Typically, the opaque coating is prepared with a binder, liquids, additives, and pigments. The paint is applied in liquid form and upon drying provides a continuous film that protects and improves the appearance of the substrate.

Suitable carriers that can be used with the mPEG-DOPA polymers to treat a substrate include solvents or solvent systems that dissolve, suspend or emulsify the polymer in such a manner that the polymer can be applied to a substrate surface, thus effectively coating the substrate. After removal of the solvent(s), typically by drying, the mPEG-DOPA remains on the substrate.

Application of the mPEG-DOPA polymer to the substrate prevents, eliminates or, at a minimum, reduces the development of the growth of one or more organisms that result in biofouling of a surface.

The following paragraphs enumerated consecutively from 1 through 9 provide for various aspects of the present invention. In one embodiment, in a first paragraph (1), the present invention provides a method to decrease or prevent biofouling of a surface comprising the step of treating a surface with an mPEG-DOPA such that biofouling is decreased or prevented.

2. The method of paragraph 1, wherein the surface is a ship hull.

3. The method of either of paragraphs 1 or 2, wherein the biofouling is from algae.

4. The method of any of paragraph 1 through 3, wherein the biofouling is from diatoms.

5. The method of any of paragraph 1 through 4, wherein the mPEG-DOPA has a formula comprising:

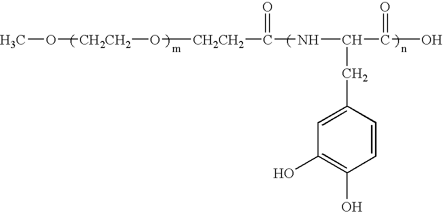

wherein n is an integer from 1 to about 100, in particular, 2 or 3; and

m is between about 2 and about 300.

6. The method of claim 5, wherein n is 1, 2 or 3.

7. The method of any of paragraph 1 through 5, wherein the mPEG-DOPA is

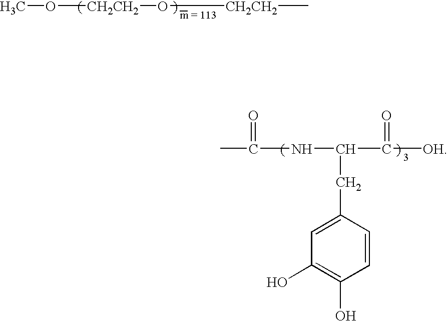

8. The method any of paragraph 1 through 6, wherein the mPEG-DOPA is provided in a carrier.

9. The method any of paragraph 1 through 7, wherein the carrier is a paint.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### EXAMPLES

The marine antifouling and fouling-release performance of titanium surfaces coated with a bio-inspired polymer was investigated. The polymer consisted of methoxy-terminated poly(ethylene glycol) (mPEG) conjugated to the adhesive amino acid L-3,4-dihydroxyphenylalanine (DOPA). Biofouling assays for the settlement and release of the diatom Navicula perminuta and settlement, growth and release of zoospores and sporelings (young plants) of the green alga Ulva linza were carried out. Results were compared to glass, a poly(dimethylsiloxane) elastomer (Silastic T2) and uncoated Ti. The mPEG-DOPA₃ modified Ti surfaces exhibited a substantial decrease in attachment of both cells of the diatom Navicula perminuta and zoospores of the green seaweed Ulva linza as well as the highest detachment of attached cells under flow compared to control surfaces. The superior performance of this polymer over a standard silicone fouling-release coating in diatom assays and approximately equivalent performance in zoospore assays demonstrate that this polymer can be effective in marine antifouling and fouling-release applications.

In summary, marine antifouling and fouling-release properties of titanium surfaces modified with mPEG-DOPA₃ were evaluated and compared to glass, glass coated with a poly(dimethylsiloxane) elastomer (PDMSE), and unmodified titanium. Settlement (adhesion) and fouling-release were assayed with the diatom Navicula perminuta and zoospores of the green alga Ulva linza. The release of sporelings (young plants) of Ulva was also determined. A substantial decrease in attachment of both Navicula cells and Ulva zoospores onto mPEG-DOPA₃-modified Ti surfaces was observed compared to all control surfaces. Furthermore, detachment of the adhered organisms under flow was highest on mPEG-DOPA₃ modified Ti surfaces, with removal of over 80% of Ulva linza spores and nearly 100% removal of Navicula perminuta.

Materials and Methods

Materials

Synthesis of mPEG-DOPA₁₋₃ has been described in detail in a previous communication (Dalsin et al., 2005 noted above). Briefly, di-, and tri-DOPA peptides (DOPA₂₋₃) were synthesized in solution from Boc/TBDMS-protected DOPA using standard carbodiimide chemistry. DOPA and DOPA peptides were deprotected and subsequently coupled to activated methoxy-PEG in the presence of 0.1 M sodium tetraborate buffer. The resulting polymer conjugate was characterized by MALDI-MS and ¹H NMR.

Borosilicate glass microscope slides were purchased from Fisher Scientific. 2-propanol and the buffer N-morpholinopropanesulfonic acid (MOPS) were purchased from Aldrich (Milwaukee, Wis.). Water used for all experiments was purified with a Millipore water treatment apparatus (≧18.2 MΩ cm, total organic content ≦5 ppb). Artificial seawater was made with ‘Tropic Marin’ sea salt (Aquarientechnik GmbH). Guillard's F2 medium for diatom culture and enriched seawater medium for Ulva sporelings were made using artificial sea water supplemented with appropriate nutrients (Guillard R R L, Ryther J H (1962) Studies on marine planktonic diatoms. 1. Cyclotella nana Hustedt and Detonula confervacea (Cleve). Can J Microbiol, 8, 229-239).

Surface Preparation and Modification

Glass microscope slides (75 mm×25 mm) were cleaned ultrasonically for ten minutes in 2-propanol, and then dried under a stream of N₂. Slides were further cleaned with a 3-min O₂ plasma exposure at ≦150 Torr and 100 W (Harrick Scientific, Ossining, USA) and then coated with a 20 nm thick layer of Ti by electron beam evaporation (Edwards Auto306; <10⁻⁵ Torr). Prior to polymer adsorption, the Ti-coated slides were cleaned as described above and then modified with mPEG-DOPA₃ by simple dip-coating in 1.0 mg ml⁻¹ mPEG-DOPA₃ in 0.6 M K₂SO₄ buffered to pH 6.0 with 0.1 M MOPS at 50° C. for 24 hours (Dalsin et al., 2005). After modification, slides were rinsed extensively with ultrapure H₂O and dried in a stream of filtered N₂. Slides modified with a coating of poly(dimethylsiloxane) elastomer (PDMSE; Silastic T2, Dow Corning) were used as a standard foul-release surface. The preparation of these surfaces has been described elsewhere (Hoipkemeier-Wilson L, Schumacher J, Carman M, Gibson A, Feinberg A, Callow M, Finlay J, Callow J, Brennan A (2004) Antifouling potential of lubricious, micro-engineered, PDMS elastomers against zoospores of the green fouling alga Ulva (Enteromorpha). Biofouling, 20, 53-63). Acid-washed glass slides and unmodified Ti-coated glass slides were included in assays as controls. All test and control surfaces were equilibrated in artificial seawater (ASW) at pH 8.0 in the dark for one hour prior to the start of bioassays.

Surface Characterization

Modification of Ti-coated slides with mPEG-DOPA₃ was confirmed by contact angle measurements, ellipsometry thickness measurements as well as x-ray photoelectron spectroscopy (XPS). The wettability of surfaces before and after modification was measured using a contact angle goniometer (Ramé-Hart, Mountain Lakes, N.J.). Advancing and receding contact angles were measured for ultrapure water on the surfaces using an auto pipetting system (Ramé-Hart, Mountain Lakes, N.J.). Three measurements were made for each surface and the mean and standard deviation were reported. A M-2000 spectroscopic ellipsometer (J. A. Woollam, Lincoln, Nebr.) was used to measure mPEG-DOPA₃ polymer thickness on Ti-coated silicon wafer substrates; glass substrates could not be used for ellipsometry measurements because a reflective surface is required for this technique. Measurements were made at 65°, 70° and 75° using wavelengths from 193-1000 nm. The spectra were fit with multilayer models in the WVASE32 software (J. A. Woollam). Optical properties of the bare substrate were fit using a standard TiO₂ model, while properties of the polymer layer were fit using a Cauchy model (Aₙ=1.45, Bₙ=0.01, Cₙ=0). The obtained ellipsometric thicknesses represent the “dry” thickness of the polymer under ambient conditions. The average thickness of three substrates is reported with standard deviation.

Survey and high resolution XPS spectra were collected on an Omicron ESCALAB (Omicron, Taunusstein, Germany) configured with a monochromated Al K_{α} (1486.8 eV) 300-W X-ray source, 1.5 mm circular spot size, a flood gun to counter charging effects, and an ultrahigh vacuum (<10⁻⁸ Torr). The takeoff angle, defined as the angle between the substrate normal and the detector, was fixed at 45°. Substrates were mounted on standard sample studs by means of double-sided adhesive tape. All binding energies were calibrated using the C(1s) carbon peak (284.6 eV). Analysis consisted of a broad survey scan (50.0 eV pass energy) and high-resolution scans (26.0 eV pass energy) at 275-295 eV for C(1s), 450-470 eV for Ti(2p) and 520-540 eV for O(1s). Curve fitting was performed using CasaXPS software with a Shirley background subtraction; atomic compositions of the surfaces were determined by normalizing peak areas using atomic sensitivity factors (Dalsin et al., 2005, noted above).

Experimental Organisms

Cultures of the diatom Navicula perminuta, originally isolated by Dr. Richard. Wetherbee (The University of Melbourne; Melbourne, Australia), were grown in F2 medium (Guillard & Ryther, 1962) at 18° C. with a 16 h:8 h, light:dark cycle. Reproductive thalli of the green macroalga Ulva linza (syn. Enteromorpha linza) (Hayden H S, Blomster J, Maggs C A, Silva P C, Stanhope M J, Waaland J R (2003) Linnaeus was right all along: Ulva and Enteromorpha are not distinct genera. European Journal of Phycology, 38, 277-294) were collected from Wembury Beach, Devon, England (50°18′ N; 4°02′ W). Zoospores were released in ASW and prepared for assays as described by Callow et al. (Callow M E, Callow J A, Pickett-Heaps J D, Wetherbee R (1997) Primary adhesion of Enteromorpha (Chlorophyta, Ulvales) propagules: Quantitative settlement studies and video microscopy. Journal of Phycology, 33, 938-947).

Settlement and Adhesion Strength of Navicula

Navicula was cultured in F2 medium contained in 250 ml conical flasks for three days until log-phase growth was achieved. Cells were washed in fresh medium (3×) before harvesting and diluting to give a suspension with a chlorophyll α content of approximately 0.3 μg ml⁻¹. Cells were settled on 6 slides of each treatment in individual dishes containing 10 ml of suspension at ˜20° C. Cells fall through the water column by gravity, thus a similar number of cells will settle onto all surfaces. After 2 h the slides were very gently washed in seawater to remove cells that had not properly attached. Three slides of each treatment were fixed in 2.5% glutaraldehyde in sea water, desalted by washing in 50:50 seawater:distilled water, followed by distilled water and dried before counting. The density of cells attached to the surface was counted on each of three replicate slides using a fluorescent microscope. On each slide, 30 fields of view (0.17 mm²) taken at 1 mm intervals along the centre were counted to provide cell attachment data.

The remaining three replicate slides were used to evaluate the strength of diatom attachment. This was achieved by exposure to a shear stress of 20 Pa in a specially designed water channel, originally described by Schultz et al. (Schultz M P, Finlay J A, Callow M E, Callow J A (2000) A turbulent channel flow apparatus for the determination of the adhesion strength of microfouling organisms. Biofouling, 15, 243-251 and Schultz M P, Finlay J A, Callow M E, Callow J A (2003) Three models to relate detachment of low form fouling at laboratory and ship scale. Biofouling, 19 (supplement), 17-26) and subsequently modified with a higher capacity pump (Finlay J A, Callow M E, Ista L K, Lopez G P, Callow J A (2002) The influence of surface wettability on the adhesion strength of settled spores of the green alga Enteromorpha and the diatom Amphora. Integrative and Comparative Biology, 42, 1116-1122). After exposure to flow the slides were fixed in glutaraldehyde and processed for counting as described above. The number of cells remaining attached was compared with unexposed control slides to determine % removal under flow.

Settlement and Adhesion Strength of Ulva

Procedures fully described elsewhere (e.g. Chaudhury M K, Finlay J A, Chung J Y, Callow M E, Callow J A (2005) The influence of elastic modulus and thickness on the release of the soft-fouling green alga Ulva linza (syn Enteromorpha linza) from poly(dimethylsiloxane)(PDMS) model networks. Biofouling, 21, 41-48) were used. In brief, 10 ml of a zoospore suspension containing 1×10⁶ spores ml⁻¹ were added to individual compartments of Quadriperm dishes, each containing one slide. The slides were incubated in the dark for 1 h, and then gently washed in seawater to remove zoospores that were still motile and hence unattached. The density of zoospores attached to the surface was counted on each of three replicate slides using an image analysis system attached to a fluorescent microscope. Spores were visualized by autofluorescence of chlorophyll and counts were reported for 30 fields of view (0.17 mm²) on each slide to provide settlement data as above.

Slides settled with zoospores for 1 h were subsequently exposed to a shear stress in the water channel used for Navicula assays. The water channel was run at maximum flow velocity creating a wall shear stress of 53 Pa. The number of spores remaining attached was compared with unexposed control slides.

Growth and Adhesion of Ulva Sporelings

Spores were allowed to settle on test surfaces as described above. After 1 hour the seawater in the mPEG-DOPA₃ dishes was only partially changed (over 66%) so that the level of water did not fall below that of the slide surface, which could have resulted in the removal of weakly attached spores. Sporelings (young plants) were cultured in enriched seawater medium in individual (10 ml) wells in polystyrene dishes under illuminated conditions inside a growth cabinet at 18° C. with a 16:8 light:dark cycle (photon flux density 330 μmol m⁻²s⁻¹). The medium was refreshed every 2 days. After an 8-day culture period, the sporeling biomass on half of each slide was removed by scraping with a razor blade, and the chlorophyll extracted in dimethyl sulphoxide (Pettitt M E, Henry S L, Callow M E, Callow J A, Clare A S (2004) Activity of commercial enzymes on settlement and adhesion of cypris larvae of the barnacle Balanus amphitrite, spores of the green alga Ulva linza, and the diatom Navicula perminuta. Biofouling, 20, 299-311 Pettitt et al., 2004). The amount of chlorophyll a present was determined spectrophotometrically using the equations of Jeffrey & Humphrey (Jeffrey S W, Humphrey G F (1975) New Spectrophotometric Equations for Determining Chlorophylls a, B, C1 and C2 in Higher-Plants, Algae and Natural Phytoplankton. Biochemie Und Physiologie Der Pflanzen, 167, 191-194). The remaining half slides of biomass (from above) were exposed to a shear stress of 53 Pa in the water channel as for the spore test. The biomass remaining in the samples was analyzed for chlorophyll a content as described above.

Results

Surface Characterization

Thorough characterization of mPEG-DOPA₃ modified Ti substrates has been reported previously (Dalsin et al., 2005); selected experiments were repeated here in order to confirm similar results on Ti-coated glass substrates. Advancing (θₐ) and receding (θᵣ) contact angles for all substrates are reported in Table I. Surfaces modified with mPEG-DOPA₃ exhibited an advancing contact angle of 33°±3° and a receding contact angle of 26°±2° for ultrapure water. These results were within the range of contact angle measurements reported for OEG-containing surfaces, confirming the presence of PEG (Branch D W, Wheeler B C, Brewer G J, Leckband D E (2001) Long-term stability of grafted polyethylene glycol surfaces for use with microstamped substrates in neuronal cell culture. Biomaterials, 22, 1035-1047; Sharma S, Johnson R W, Desai T A (2004) Evaluation of the stability of nonfouling ultrathin poly-(ethylene glycol) films for silicon-based microdevices. Langmuir, 20, 348-356). The dry adsorbed polymer thickness was measured using spectroscopic ellipsometry; an average thickness of 31.4±5.1 Å was measured for mPEG-DOPA₃ on Ti-coated substrates.

TABLE I
Advancing and receding water contact angles

Water contact angles (deg)

| | advancing | receding |
|---|---|---|
| Glass | <15 | <15 |
| PDMSE^{a} | 115 ± 4 | 69 ± 2 |
| Ti Control | 24 ± 6 | 15 ± 4 |
| mPEG-DOPA₃ | 33 ± 3 | 26 ± 2 |

^{a}As reported in Hoipkemeier-Wilson et al.

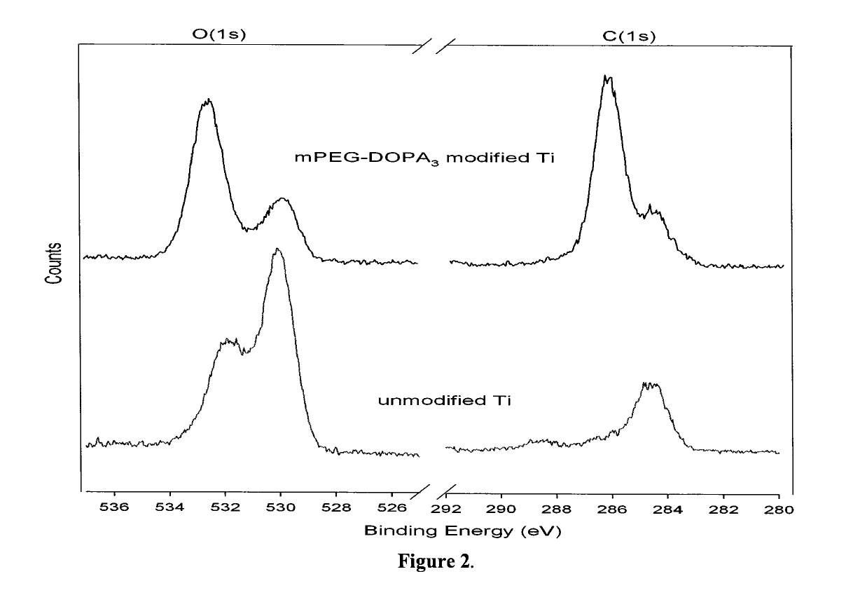

High-resolution XPS spectra were acquired from unmodified Ti and mPEG-DOPA₃ modified Ti substrates; atomic compositions of the substrates are reported with corresponding binding energies in Table II. The unmodified Ti substrates exhibited strong peaks for titanium and oxygen, as expected for the clean oxide layer; a weaker signal for carbon, most likely from hydrocarbon contamination, was also detected. The mPEG-DOPA₃ modified Ti substrates exhibited weaker signals for titanium and oxygen and stronger signals for carbon. The C1s spectra were further resolved into three components: C—C (284.6 eV), C—O (286.0 eV), and C═O (288.0 eV). The C—C component was attributed to the DOPA side chain, and NC═O is for the peptide amide bond. The large increase in the C—O component for the mPEG-DOPA₃ modified substrates indicated the presence of the PEG ether carbons. The high resolution O(1s) and C(1s) spectra for mPEG-DOPA₃ modified Ti and unmodified Ti are shown in FIG. 2. Collectively, these results confirm the presence of a thin coating of mPEG-DOPA₃ on the substrates used in biofouling experiments.

TABLE II
Quantitative analysis of XPS data for substrates

| | Atomic Composition [atom %] (binding energies [eV]) | | | | | | |
|---|---|---|---|---|---|---|---|
| | | O | | | C | | |
| Substrate | Ti | TiO₂ | TiOH | C—O, H₂O | C—C, C—H | C—O | C═O |
| Bare Ti | 26.3 | 40.7 | 10.1 | 6.4 | 12.7 | 2.6 | 1.2 |
| | (458.6) | (530.0) | (531.5) | (532.3) | (284.6) | (286.4) | (288.5) |
| mPEG-DOPA₃ | 5.5 | 22.5 | 2.3 | 22.5 | 10.1 | 35.8 | 1.3 |
| | (460.4) | (529.9) | (531.1) | (532.6) | (284.6) | (286.3) | (288.0) |

Settlement and Attachment Strength of Navicula

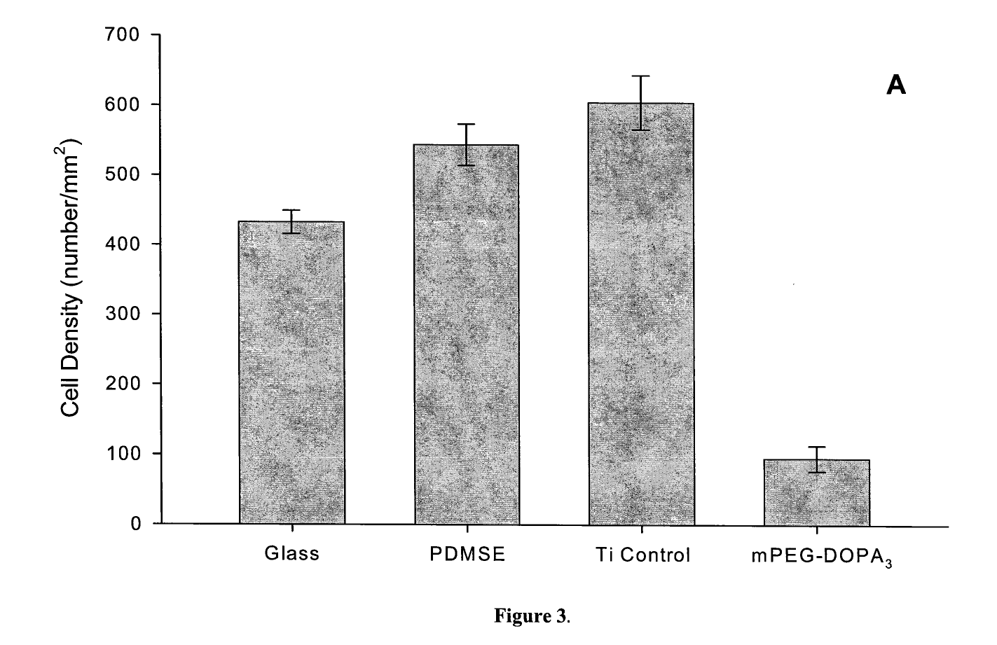

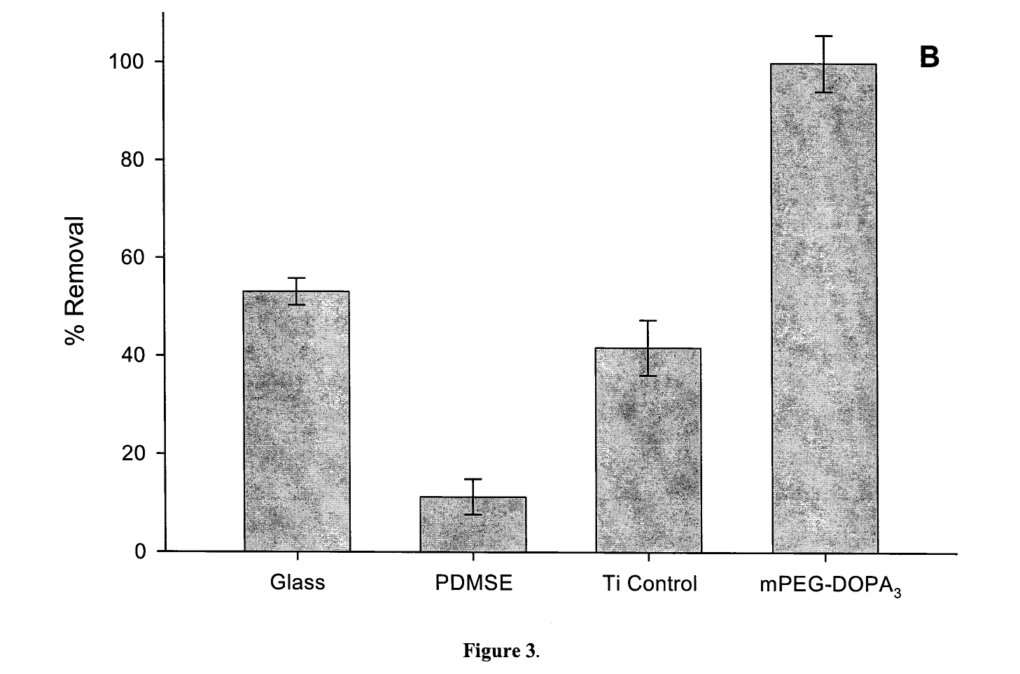

Diatoms adhered at approximately equal densities on the glass, PDMSE, and titanium control surfaces. On the mPEG-DOPA₃ coated slide, however, the number of cells attached was significantly lower compared to any of the other surfaces (one-way analysis of variance F_{3, 356}=267 P<0.05) (FIG. 3). Since diatoms settle through the water column and onto surfaces under the influence of gravity, initially there would have been as many cells per unit area in contact with the mPEG-DOPA₃ slide as the other surfaces. However, the low observed cell density on the mPEG-DOPA₃ surface indicates that most of the cells that initially attached were lost at the rinsing stage, demonstrating very weak attachment strength to this surface, perhaps a result of the steric hindrance of the PEG chains.

Removal of cells under shear (20 Pa) from the titanium control was similar to that from glass (approx. 40-50%), whereas removal from the PDMSE standard was low (approx. 10%). The latter result is expected as it is well documented that diatoms adhere strongly to fouling release silicone elastomers 9Terlizzi A, Conte E, Zupo V, Mazzella L (2000) Biological succession on silicone fouling-release surfaces: Long-term exposure tests in the harbour of Ischia, Italy. Biofouling, 15, 327-342; Holland R, Dugdale T M, Wetherbee R, Brennan A B, Finlay J A, Callow J A, Callow M E (2004) Adhesion and motility of fouling diatoms on a silicone elastomer. Biofouling, 20, 323-329; Holm E R, Schultz M P, Haslbeck E G, Talbott W J, Field A J (2004) Evaluation of hydrodynamic drag on experimental fouling-release surfaces, using rotating disks. Biofouling, 20, 219-226). By contrast, detachment of the relatively few attached diatoms from the mPEG-DOPA₃ surfaces was almost total (one-way analysis of variance on arcsine transformed data F_{3, 356}=342 P<0.05) (FIG. 3). The high level of diatom release from these surfaces further demonstrated very weak interaction between the organisms and the PEG surface.

Settlement and Attachment Strength of Ulva Zoospores

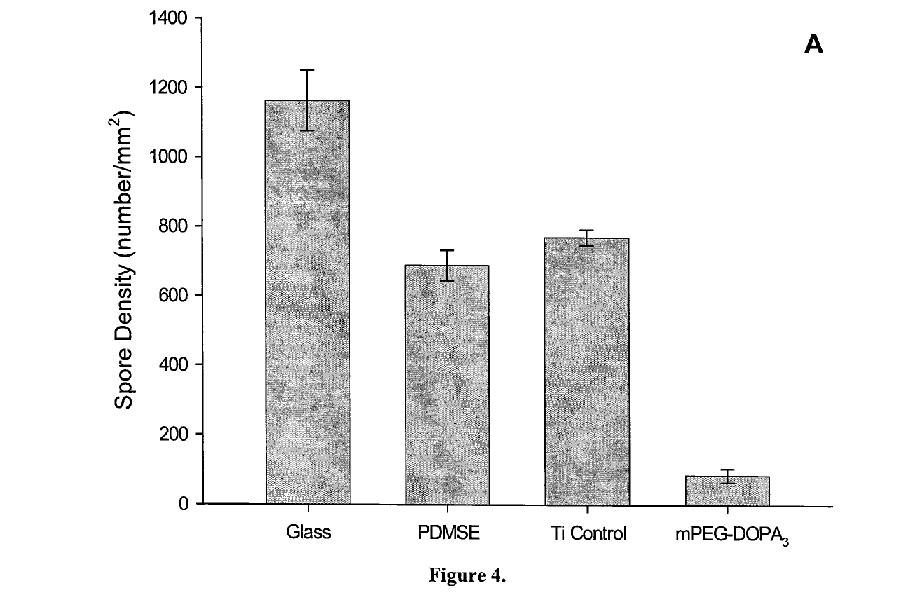

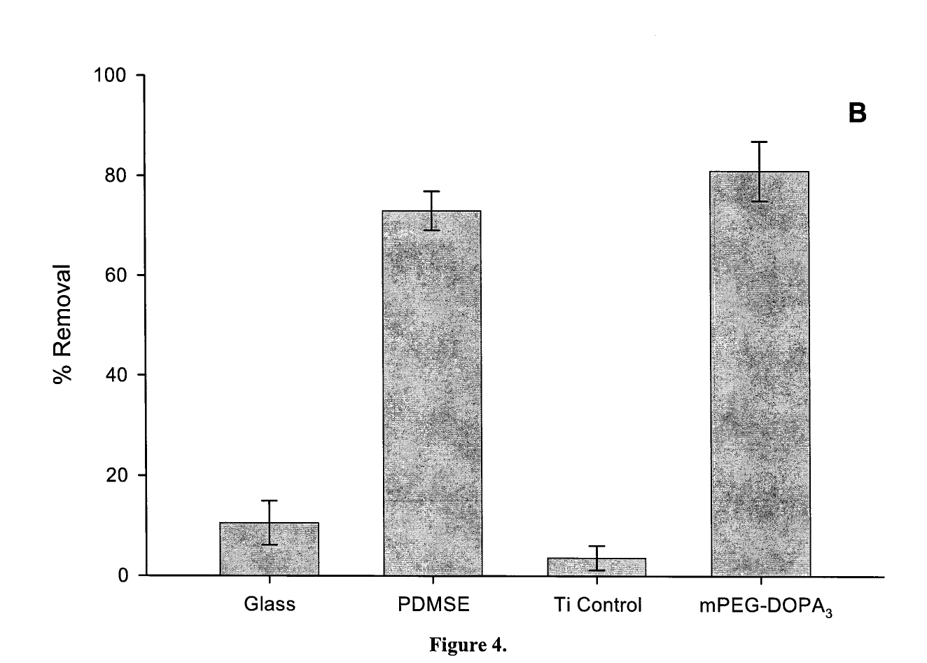

Zoospores readily settled and attached to the titanium-coated control slides, the settlement density being similar to that on the PDMSE standards, but less than on the glass slides. However, levels of spore settlement on the mPEG-DOPA₃ coated slides were extremely low (one-way analysis of variance F_{3, 356}=294 P<0.05) compared to either glass and titanium controls, or the PDMSE standard (FIG. 4).

While some spores did settle on the surface of the mPEG-DOPA₃ samples, the attachment strength was so weak that the cohesive forces of water removed the spores during removal of the slide from the dish and passage through the air/water interface. On removal from the dish, the displaced spores could be seen as concentrated floating green rafts of cells on the surface of the seawater.

The few spores that remained attached to the mPEG-DOPA₃ surface following removal from the dish were only weakly adhered compared to the other surfaces (FIG. 4). Spore removal exceeded 80% on the mPEG-DOPA₃ surfaces, similar to that from PDMSE standards, but significantly different to glass and titanium controls, from which <10% of the spores were removed (one-way analysis of variance on arcsine transformed data F_{3, 356}=218 P<0.05).

Growth and Attachment Strength of Ulva Sporelings

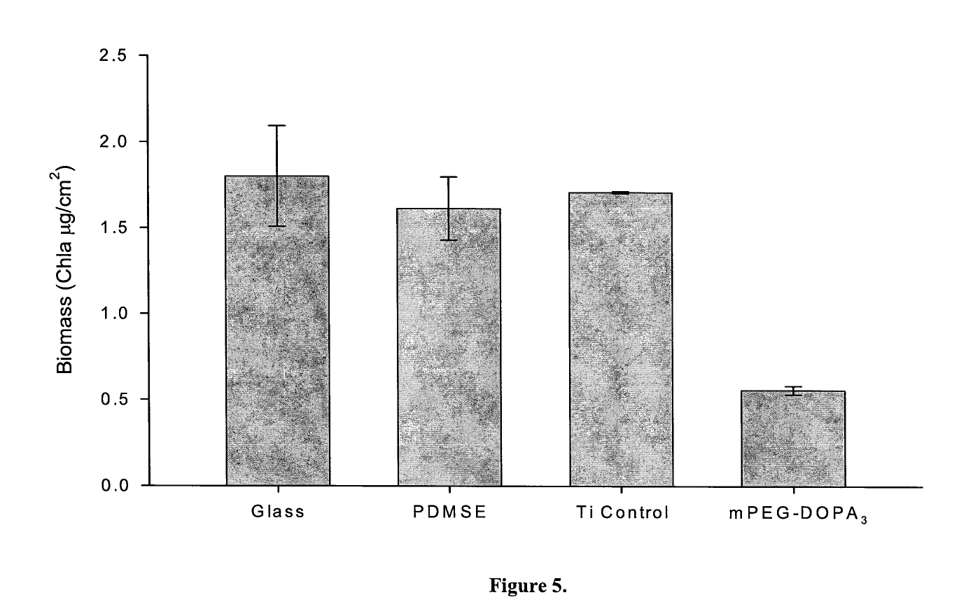

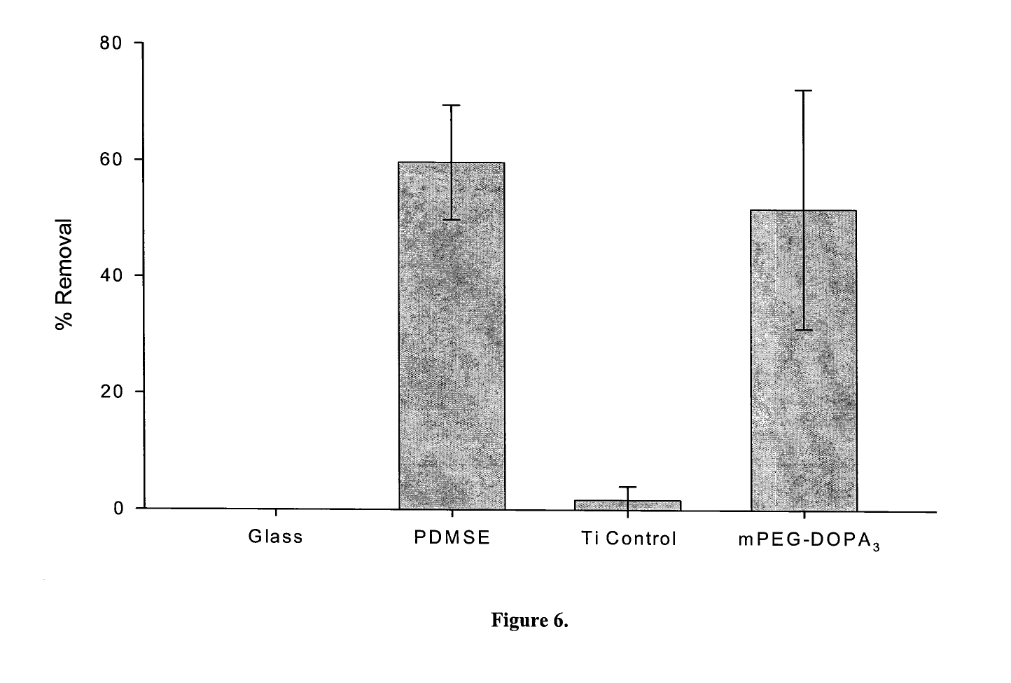

After 8 days in culture, the growth of sporelings was similar on the glass, PDMSE and titanium-coated surfaces, while growth was significantly reduced (<40% of the level on glass) on the mPEG-DOPA₃ modified substrates (one-way analysis of variance F_{3, 12}=7.3 P<0.05) (FIG. 5). Exposure to a shear stress of 53 Pa, caused very little of the Ulva biomass to be removed from the glass and titanium-coated controls (FIG. 6), but approximately 60% and 52% of biomass was removed from the PDMSE and the mPEG-DOPA₃ coatings respectively. There was no significant difference between these two treatments.

Discussion

The antifouling and fouling-release properties of mPEG-DOPA₃ coatings were demonstrated through assays with the diatom Navicula and zoospores of the green seaweed Ulva. Diatoms are unicellular algae that readily form biofilms, often referred to as ‘slime’, on illuminated submerged surfaces (Callow J A, Stanley M S, Wetherbee R, Callow M E (2000) Cellular and molecular approaches to understanding primary adhesion in Enteromorpha: an overview. Biofouling, 16, 141-150; Kavanagh C J, Quinn R D, Swain G W (2005) J Adhesion, 81, 843-868). Attachment to the substrate is through the secretion of a range of complex proteoglycans (Chiovitti A, Dugdale T M, Wetherbee R (2006) Chapter 5, pages 77-99; Diatom adhesives: molecular and mechanical properties. In: Biological Adhesives (eds A Smith & J A Callow). Springer). The green algal genus Ulva comprises the most widespread species of alga that fouls man-made structures in the marine environment (Hayden H S, Blomster J, Maggs C A, Silva P C, Stanhope M J, Waaland J R (2003) Linnaeus was right all along: Ulva and Enteromorpha are not distinct genera. European Journal of Phycology, 38, 277-294). Fouling by Ulva occurs through the settlement of motile zoospores on available surfaces and secretion of adhesive glycoproteins (Stanley M S, Callow M E, Callow J A (1999) Monoclonal antibodies to adhesive cell coat glycoproteins secreted by zoospores of the green alga Enteromorpha. Planta, 210, 61-71; Callow J A, Stanley M S, Wetherbee R, Callow M E (2000) Cellular and molecular approaches to understanding primary adhesion in Enteromorpha: an overview. Biofouling, 16, 141-150; Humphrey A J, Finlay J A, Pettit M E, Stanley M S, Callow J A (2005) Effect of Ellman's Reagent and dithiothreitol on the curing of the spore adhesive glycoprotein of the green alga. Ulva J Adhesion, 81, 791-803; Walker G C, Sun Y, Guo S, Finlay J A, Callow M E, Callow J A (2005) Surface mechanical properties of the spore adhesive of the green alga Ulva. Journal of Adhesion, 81, 1101-1118; Krishnan S, Ayothi R, Hexemer A, Finlay J A, Sohn K E, Perry R, Ober C K, Kramer E J, Callow M E, Callow J A, Fischer D A (2006a) Anti-Biofouling Properties of Comblike Block Copolymers with Amphiphilic Side Chains. Langmuir, 22 (11), 5075-5086, 2006. Once anchored to a surface, the settled Ulva zoospores germinate into sporelings and ultimately grow into mature plants. The attachment strength of Ulva sporelings is low on fouling-release coatings (Schultz M P, Finlay J A, Callow M E, Callow J A (2003) Three models to relate detachment of low form fouling at laboratory and ship scale. Biofouling, 19 (supplement), 17-26; Chaudhury M K, Finlay J A, Chung J Y, Callow M E, Callow J A (2005) The influence of elastic modulus and thickness on the release of the soft-fouling green alga Ulva linza (syn Enteromorpha linza) from poly(dimethylsiloxane)(PDMS) model networks. Biofouling, 21, 41-48).

The weak attachment strength and high percentage of removal of Navicula cells on mPEG-DOPA₃ surfaces demonstrated a significant advantage for this hydrophilic coating over hydrophobic fouling-release silicone elastomers, from which diatoms were not readily released (Terlizzi A, Conte E, Zupo V, Mazzella L (2000) Biological succession on silicone fouling-release surfaces: Long-term exposure tests in the harbour of Ischia, Italy. Biofouling, 15, 327-342; Holland R, Dugdale T M, Wetherbee R, Brennan A B, Finlay J A, Callow J A, Callow M E (2004) Adhesion and motility of fouling diatoms on a silicone elastomer. Biofouling, 20, 323-329; Holm E R, Schultz M P, Haslbeck E G, Talbott W J, Field A J (2004) Evaluation of hydrodynamic drag on experimental fouling-release surfaces, using rotating disks. Biofouling, 20, 219-226).

The densities of attached Ulva zoospores and sporelings were lower on mPEG-DOPA₃ surfaces compared to the control surfaces, and the percentage removal of Ulva from mPEG-DOPA₃ surfaces was comparable to results for the PDMSE fouling-release standard used in this study.

Conclusions

The present invention demonstrated that a non-toxic, polymer-based approach that exploits the adhesive behavior of marine mussels can paradoxically reduce marine algal fouling. The substantial reduction in initial settlement of both Navicula cells and Ulva zoospores on mPEG-DOPA₃-modified titanium establishes these coatings as novel remedies to marine fouling. Importantly, the fouling-release characteristics of the mPEG-DOPA₃ films appeared to be equivalent to a PDMS elastomer for Ulva, but surpassed the performance of the elastomer for the diatom Navicula. The nontoxic nature of the PEG films makes them especially attractive from an environmental standpoint, and the simple aqueous coating method provides for facile application.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A method to decrease or prevent biofouling of a surface comprising the step of treating a surface with an mPEG-DOPA such that biofouling is decreased or prevented.

2. The method of claim 1, wherein the surface is a ship hull.

3. The method of claim 1, wherein the biofouling is from algae.

4. The method of claim 1, wherein the biofouling is from diatoms.

5. The method of claim 1, wherein the mPEG-DOPA has a formula comprising: 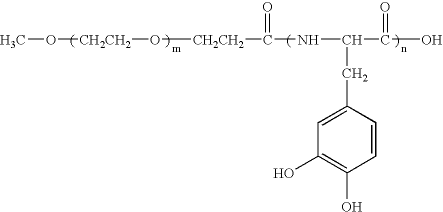
wherein n is from 1 to about 100; and
m is between about 2 and about 300.

6. The method of claim 5, wherein n is 1, 2 or 3.

7. The method of claim 5, wherein the mPEG-DOPA is

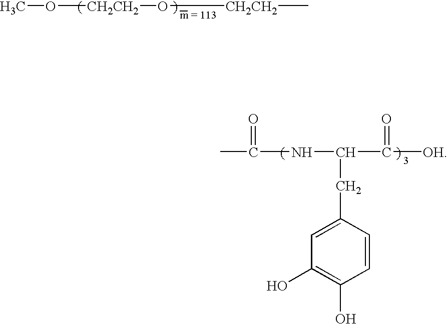

8. The method of claim 1, wherein the mPEG-DOPA is provided in a carrier.

9. The method of claim 7, wherein the carrier is a paint.
